(19) United States
(12) Patent Application Publication
(10) Pub. No.: US 2009/0146732 A1
(43) Pub. Date: Jun. 11, 2009

(54) Constant Current Source Circuit

(76) Inventor: WEI-KUO WU, Guang Zhou Science City (CN)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/253,384

(22) Filed: Oct. 17, 2008

(30) Foreign Application Priority Data
Dec. 5, 2007 (CN) 200710032174.1

(51) Int. Cl. G05F 1/10

(52) U.S. Cl. 327/543

(57) ABSTRACT

The present invention discloses a constant current source circuit with energy saving and over voltage protection to provide a constant current source circuit with less elements, simple circuitry, energy saving and over voltage protection. The present invention includes a regulating circuit (1), a filtering capacitor (2) and a load (3), and further includes a depletion mode FET (field effect transistor) (4). The present invention can generally be applied to the lamps, wherein the load are high voltage LED (light emitting diode) elements or a lamp composed of several LED elements serial connected or serial-parallel connected. This invention can also be applied to the load that is an electronic circuit with high working voltage. This invention can also be applied to the load that is a DC motor with high working voltage. This invention can also be applied to the load that is an electrical thermal load with high resistivity.

### BACKGROUND OF THE INVENTION

1. Field of the Invention

The present invention is related to a constant current source circuit having function of energy saving and over voltage protection.

2. Description of the Related Art

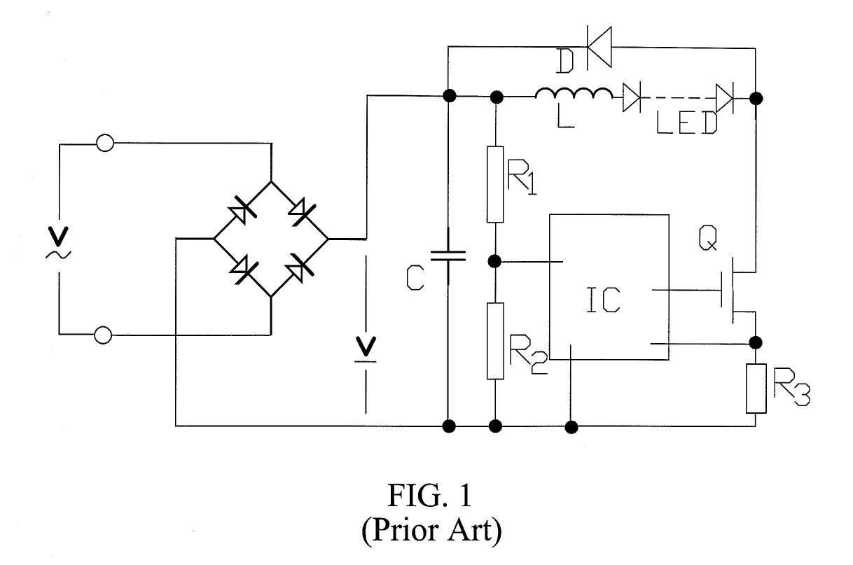

In the practical needs and applications, although many loads do not have large power consumption, they require the electrical power that can maintain their currents and voltages relatively stable within a certain range. Meanwhile, the power supply is required to provide certain protection functions for some elements inside the load. To solve these electricity supply issues in the load, it normally adopts a constant current or voltage stabilization power, and the over current protection circuit still needs to be added in the power circuit to protect some elements of the load in abnormal condition. Thus, this will arouse too many power elements, too complex circuit, and large proportion of wasted power. As shown in FIG. 1, which shows a prior art of the constant current and constant voltage circuit normally used in the market for LED. Although the LED itself does not have large power consumption, in order to achieve a constant current and constant voltage application, it needs to add one additional control IC, power transistor (Q), inductance (L), fast recovery diode (D), and three resistors (R1 □ R2 and R3). These elements (especially power transistors) will consume some power more or less Thus, the original LED application should have function of electricity saving, but due to the circuit for achieving constant current and voltage, it cannot achieve the purpose of energy saving and power preservation anymore.

In short, as aforementioned, the traditional constant current or voltage stabilization power circuit diagram for some loads application continuing used in the current technology exists the drawbacks of more elements, complex circuitry, and waste of energy.

### SUMMARY OF THE INVENTION

The present invention is provided to solve the deficiency in the prior art and to have a constant current source circuit with less elements, simple circuitry, energy saving and over voltage protection.

The present invention comprises a regulating circuit, a filtering capacitor and a load, and further includes a depletion mode FET (field effect transistor). An AC (alternative current) input of the regulating circuit is connected with the AC power, and DC (direct current) output of the regulating circuit is parallel-connected with the filtering capacitor, a drain of the depletion model FET is connected with one end of the DC output of the regulating circuit, a source and a gate of the depletion model FET are linked and connected with one end of the load, and the other end of the load is linked and connected with the other end of the DC output of the regulating circuit.

The load can be high voltage LED (light emitting diode) elements or a lamp composed of several LED elements serial connected or serial-parallel connected.

The load can be an electronic circuit with high working voltage.

The load can be a DC motor with high working voltage. Alternatively, the load can be an electrical thermal load with high resistivity.

The advantages of the present invention can achieve fewer elements required, simpler circuitry, more energy saving and over voltage protection. Due to that the present invention includes a regulating circuit, a filtering capacitor and a load, and further includes a depletion mode FET, an AC input of the regulating circuit is connected with the AC power, and DC (direct current) output of the regulating circuit is parallel-connected with the filtering capacitor, a drain of the depletion model FET is connected with one end of the DC output of the regulating circuit, a source and a gate of the depletion model FET are linked and connected with one end of the load, and the other end of the load is linked and connected with the other end of the DC output of the regulating circuit. Thus, present invention is provided with a constant current source circuit with less elements, simple circuitry, energy saving and over voltage protection.

### BRIEF DESCRIPTION OF THE INVENTION

FIG. 1 is a schematic diagram of a traditional application circuit of the constant current and constant voltage for LED normally used in the market.

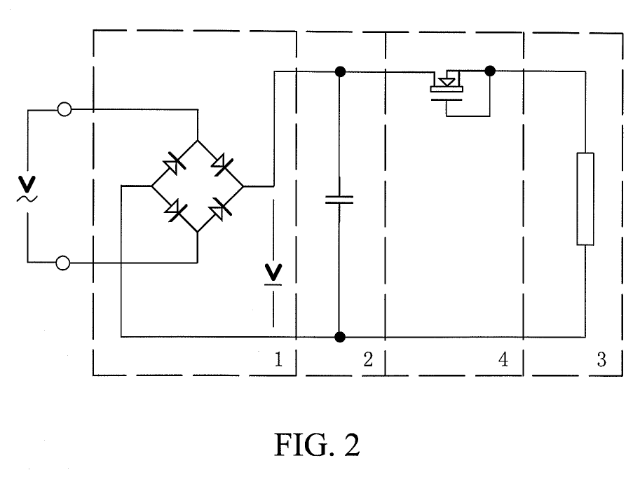

FIG. 2 is a schematic diagram of the present invention.

### DETAILED DESCRIPTION OF THE PREFERRED EMBODIMENT

As shown in FIG. 2, the present invention includes a regulating circuit 1, a filtering capacitor 2 and a load 3, and further includes a depletion mode FET (field effect transistor) 4. An AC (alternative current) input of the regulating circuit 1 is connected with the AC power, and DC (direct current) output of the regulating circuit 1 is parallel-connected with the filtering capacitor 2. A drain of the depletion model FET 4 is connected with one end of the DC output of the regulating circuit 1. A source and a gate of the depletion model FET) 4 are linked and connected with one end of the load 3, and the other end of the load 3 is linked and connected with the other end of the DC output of the regulating circuit 1.

The load 3 can be high voltage LED (light emitting diode) elements or a lamp composed of several LED elements serial connected or serial-parallel connected.

The load 3 can be an electronic circuit with high working voltage.

The load 3 can be an electrical thermal load with high resistivity.

The load 3 can be a DC motor with high working voltage. In the practical applications, series of LEDs can be serial connected such that the total voltage of all serial connected LED closes to but merely 3□5 volts lower than the DC voltage after regulating. Then, the positive pole end of the LED elements is connected with the source/gate end of the depletion FET by serial connection, and the drain of the depletion FET is connected with the positive pole end by regulating and filtering. The saturation current of gate and source under the same potential of the depletion FET can be adjusted according to the current requirement for the LED elements. Thus, a constant current can be provided to the LED elements. While the AC voltage is unstable and especially is higher than normal voltage, the part of over voltage will be added in between the drain and the source of the depletion FET without influencing the LED elements. It thus can achieve to protect the LED elements by voltage stabilization and protection function.

If the AC voltage is lower than normal voltage, the part of under voltage will firstly lower the voltage between the drain and the source of the depletion FET, then the redundant part will be equally shared by every serial connected LEDs. The result causes no damage to the LED except causing the decreasing in the current passing through the LED, and furthermore causes no meaningless power consumption. Therefore, it can make the LED elements intrinsically achieve the objects of energy conservation and power saving. For every white light LED working under 3.2 volts/30 mA (milli-ampere), if the whole 96 LEDs are serial connected together, the total voltage is about 307.2 volts and the output of the 220 volts AC is about 311V after being regulated and filtered. Therefore, if the drain of the depletion FET with an output current of 30 mA is connected to the output of the regulating and the filtering, and the source and the gate are connected to the positive pole end of LED elements, the voltage drop between the drain and the source of the depletion FET will be about 3.88 volts. And, the power consumption of whole circuit will be about 9.33 watts (=96×3.2×0.03+3.88×0.03). The total loss in the depletion FET is only 0.116 watts (=3.88×0.03). The loss is only 1.2% of the total power consumption. Due to that the variation in AC voltage is between plus and minus 30 volts, the variation after regulating and filtering is between plus and minus 45 volts. If the voltage resisting ability of the depletion FET can be more than 50 volts, the depletion FET can protect the LED elements from over voltage when AC power's voltage is unstable.

The method for manufacturing the depletion mode FET 4 in the present embodiment includes the following steps:

1. P-typed silicon substrate is thermal oxidized in the oxidation furnace to grow an oxide layer protecting film. Then, a first photo mask is utilized to process the photolithography in a photolithography machine, and a corrosive liquid containing the HF (hydrofluoric acid) is used to etch the oxide layer's protecting film.

2. The p-type ions such as the boron difluorides or boron ions are implanted in the silicon substrate. Furthermore, they are thermally driven-in to form the P+ guard ring and the P+ contacting region contacted with the substrate.

3. A second photo mask is used to process the photolithography in a photolithography machine; furthermore a dry etching method is used to etch the oxide layer. Then, an ion implanter is used to implant the arsenic ions in the silicon substrate to form the heavily doped N+ region, that is, the N+ source region, N+ drain region and N+ guard ring.

4. A third photo mask is used to process the photolithography in a photolithography machine, and a corrosive liquid containing the HF (hydrofluoric acid) is used to etch the oxide layer of resist region, furthermore the dry/wet thermal oxidation to form the gate oxide layer. Then, the phosphorous ions are implanted. Furthermore, thermally driven-in is used to finally form an N− channel region and an oxide layer.

5. A fourth photo mask is used to process the photolithography in a photolithography machine; furthermore an etching method is used to etch the oxide layer to form drain through holes, source N+ through holes, and source P+ substrate through holes.

6. A sputtering or evaporation method is used to deposit a metal layer. Then, a metal layer mask is utilized to process the photolithography in a photolithography machine. Furthermore, a dry or wet etching method is used to etch the metal layer to form the drain metal, the source metal, the gate metal, and a connection metal.

Although the present invention has been explained in relation to its preferred embodiment, it is to be understood that many other possible modifications and variations can be made without departing from the spirit and scope of the invention as hereinafter claimed.

What is claimed is:

1. A constant current source circuit comprising:
a regulating circuit comprising an AC (alternative current) input and a DC (direct current) output;
a filtering capacitor;
a load; and
a depletion mode FET (field effect transistor) comprising a drain, a source, and a gate;
wherein the AC input of the regulating circuit is connected with an AC power source, the DC (direct current) output of the regulating circuit is parallel-connected with the filtering capacitor, the drain of the depletion model FET is connected with one end of the DC output end of the regulating circuit, the source and the gate of the depletion model FET are connected with each other and connected with one end of the load, and the other end of the load is connected with the other end of the DC output of the regulating circuit.

2. The constant current source circuit of claim 1, wherein the load is high voltage LED (light emitting diode) elements or a lamp composed of several LED elements that are serial connected or serial-parallel connected.

3. The constant current source circuit of claim 1, wherein the load is an electronic circuit with high working voltage.

4. The constant current source circuit of claim 1, wherein the load is a DC motor with high working voltage.

5. The constant current source circuit of claim 1, wherein the load is an electrical thermal load with high resistivity.
